(19) United States
(12) Patent Application Publication
(10) Pub. No.: US 2010/0302032 A1
(43) Pub. Date: Dec. 2, 2010

(54) SYSTEM AND METHOD TO LOCATE MISPLACED PERSONAL ITEMS

(75) Inventor: Sany Abed, Okotoks (CA)

Correspondence Address: Raj Abhyanker, P.C., 1580 West, El Camino Real, Suite 8, Mountain View, CA, 94040, US

(73) Assignee: Sany Abed, Okotoks, AB (CA)

(21) Appl. No.: 12/790,992

(22) Filed: Jun. 1, 2010

Related U.S. Application Data
(60) Provisional application No. 61/183,111, filed on Jun. 2, 2009.

(51) Int. Cl. G08B 1/08

(52) U.S. Cl. 340/539.32

(57) ABSTRACT

A system and method to locate a personal item of a user on misplacing the personal item is provided. In one embodiment, the system includes a receiver object affixed on a surface of the personal item to audibly emit predetermined sound for a predetermined amount of time when the receiver object receives a signal having a certain frequency unique to the receiver object. The system further includes a transmitter device electronically coupled with a data processing system through a Universal Serial Interface (USB) port of the data processing system. In addition, the system includes a processor of the data processing system. The processor authenticates the user of the data processing system and associates a set of personal items with a set of receiver objects. The processor also associates the personal item with the user based on a profile of the user and determines that the personal item is misplaced.

### CLAIM OF PRIORITY

This application claims the benefit of U.S. Provisional Application No. 61/183,111 titled “SEEK-ALL” filed on Jun. 2, 2009. The entire teachings of the above application are incorporated herein by reference.

### FIELD OF TECHNOLOGY

This disclosure relates generally to automatic object location detection and, in one example embodiment, to system and method to locate a misplaced personal item of a user.

### BACKGROUND

Most often people tend to misplace small personal items, such as wallets, keys, and remotes daily. The process of locating the misplaced personal items can be extremely frustrating and time consuming. Individuals find themselves flipping couch cushions, searching the yard or the car, and tearing the house apart looking for the misplaced personal items. For example, when a cellular phone is misplaced and is turned off or the battery of the cellular phone is dead, there is no way to locate the cellular phone. Keys are one of the most common items to be misplaced due to small size. While traveling, important personal items, including, for example, hotel keys and passports can go missing. Children may also lose personal items including, for example, mittens, bottles, toys, or other soothing affects. There is no quick, easy way to locate items that have gone missing. Many individuals spend hours looking for misplaced personal items that may never be found. A more effective method and system that can be used by people of all ages is needed to locate the misplaced personal items.

### SUMMARY

In one aspect, a system includes a personal item. The system also includes a receiver object affixed on a surface of the personal item to audibly emit a predetermined sound for a predetermined amount of time when the receiver object receives a signal having a certain frequency unique to the receiver object. In addition, the system includes a transmitter device electronically coupled with a data processing system.

The system further includes a processor of the data processing system to authenticate a user of the data processing system. The processor of the system also associates a set of personal items with a set of receiver objects and associates the personal item with the user based on a profile of the user. The processor of the system also determines that the personal item is misplaced based on a response of the user and to issue the command to transmit the signal to the receiver object affixed to the surface of the personal item.

The receiver object may include a battery, a microcontroller, a receiver, and an audio circuit to generate the sound when the receiver object receives the signal having the certain frequency. The data processing system may be one or more of a personal computer, a laptop, a personal digital assistant, and a mobile communication device. The personal item may be any one of a key, a key chain, an electronic device, a set of eyeglasses, a jewelry item, and any item having personal value to the user. The transmitter device may be electronically coupled with a data processing system through a Universal Serial Interface (USB) port of the data processing system, an in-built wireless technology and an in-built Bluetooth technology. The receiver object may be affixed to the personal item through a sticky tape, a glue, and a double-sided peel able sticker between the receiver object and the personal item. The transmitter device may operate on one or more of a radio frequency, a microwave signal, a Bluetooth signal, an analog signal, and a digital signal.

The operations of the processor may be controllable through a web enabled software in which a user account associated with the user may be stored in a server device. The data processing system may acquire a profile information associated with the user account through the server device. The user may control any number of distinct personal items to recall based on frequency profiles of individual ones of the distinct personal items. A user interface associated with the web enabled software may be color coded and numerically sequenced for easy identification of the personal item. The personal item may be within 250 feet of the data processing system such that the signal can permeate an air space between the data processing system and the receiver device with minimum power consumption. The system may provide a reliable method of locating misplaced items. The transmitter device may run the web enabled software on the data processing system and transmit the signal to a corresponding receiver object when the user accesses the user account and select a particular personal item to locate. The corresponding receiver object affixed on the particular personal item may receive the signal and emit the predetermined sound. The predetermined sound may be one or more of a human voice, a default sound programmed into the receiver object and a user-programmed sound.

In another aspect, a method includes authenticating a user of the data processing system to associate a personal item with the user. The method also includes associating the personal item with a corresponding receiver object through a processor of the data processing system. In addition, the method includes issuing a command to transmit a signal having a certain frequency unique to the corresponding receiver object affixed to a surface of the personal item based on a response of the user. The method also includes automatically transmitting the signal through a transmitter device coupled with the data processing system through a Universal Serial Interface (USB) port of the data processing system.

The method further includes receiving the signal through the receiver object affixed on a personal item. In addition, the method includes emitting a predetermined sound for a predetermined amount of time when the receiver receives the signal. The method also includes determining a location of the personal item through a response of the user based on the emitted predetermined sound. The method may further include controlling a set of operations associated with the processor through a web enabled software. The method may also include storing a user account associated with the user in the server device accessible through the web enabled software. In addition, the method also includes selecting a set of options associated with a group of receiver objects through the user account. The set of options associated with the set of receiver objects may be one or more of a set of frequency profiles of the receiver objects, a set of options associated with personal information stored in the user account, and a set of display options of the user account. A user interface associated with the web enabled software may be color coded and numerically sequenced for easy identification of the personal item.

The data processing system may be one or more of a personal computer, a laptop, a personal digital assistant, and a mobile communication device. The personal item may be any one of a key, a key chain, an electronic device, a set of eyeglasses, a jewelry item, and any item having personal value to the user. The transmitter device may operate on one or more of a radio frequency, a microwave signal, an analog signal, and a digital signal. The method may also include permitting the user to track a frequency of a usage of the receiver objects, to reorder a set of additional components, to access technical support information, to download a set of component codes, and to upload a set of user information.

In yet another aspect, a method of locating a misplaced item includes transmitting a signal having a unique frequency through a transmitter device coupled with a data processing system. The method of locating the misplaced item also includes receiving the signal having the unique frequency through a receiver object affixed on the misplaced item. The method of locating the misplaced item further includes emitting a predetermined audible sound when the receiver object receives the signal and locating the misplaced item based on the predetermined audible sound. In addition, the method of locating the misplaced item may include permitting a user to select a set of options associated with the receiver object in a user account accessible through a web enabled software.

The methods, systems, and apparatuses disclosed herein may be implemented in any means for achieving various aspects, and may be executed in a form of a machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates a system to locate one or more personal items of a user of the system, in accordance with one or more embodiments.

FIGS. 2A-2B is a system view illustrating an interaction flow, according to one or more embodiments.

FIG. 3 illustrates a screen shot showing a user interface of the data processing system enabled with a web enabled software to locate a misplaced personal item, in accordance with one or more embodiments.

FIGS. 4A-4C illustrate an example scenario of locating a misplaced key of a user through a personal digital assistant of the user, in accordance with one or more embodiments.

FIG. 5 is a flow diagram illustrating a method of locating a personal item of a user misplaced by the user, in accordance with one or more embodiments.

FIG. 6 is a flow diagram illustrating a method of locating a personal item of a user misplaced by the user, in accordance with one or more embodiments.

Other features of the present embodiments will be apparent from the accompanying drawings and from the detailed description that follows.

### DETAILED DESCRIPTION

A system and/a method to locate one or more misplaced personal items are disclosed. Although the present embodiments have been described with reference to specific example embodiments, it will be evident that various modifications and changes may be made to these embodiments without departing from the broader spirit and scope of the various embodiments.

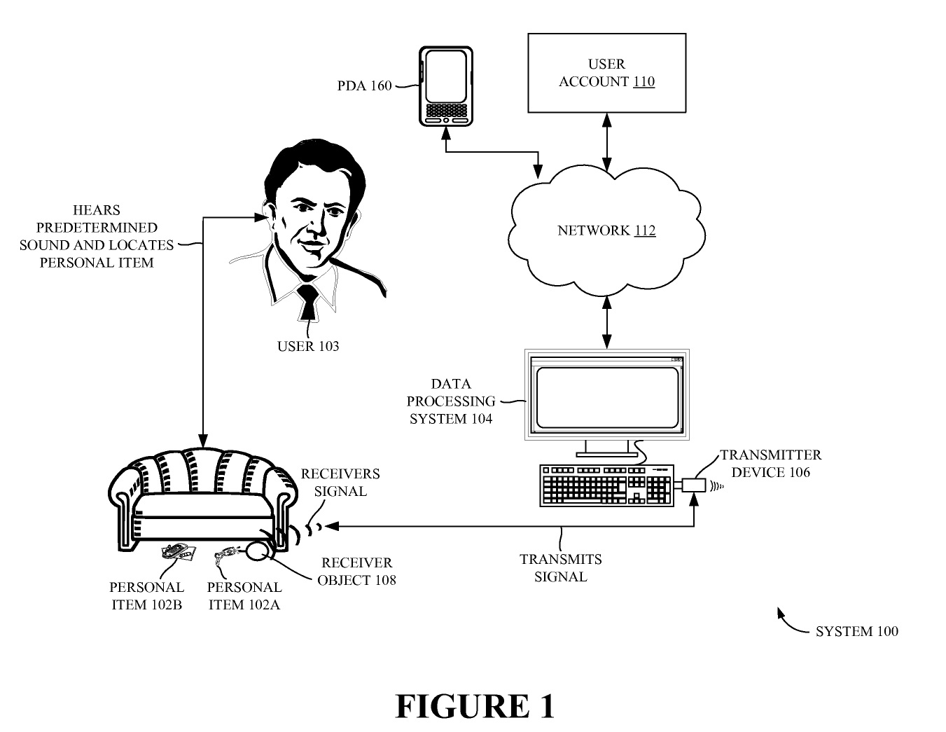

FIG. 1 illustrates a system 100 to locate one or more personal items (e.g., personal item 102A and personal item 102B) of a user 103 of the system 100, in accordance with one or more embodiments. Examples of the personal item may include, but is not limited to a key, a key chain, an electronic device, a set of eyeglasses, a jewelry item, and any item having personal value to the user 103. The system 100 may include a data processing system 104, and a personal digital assistant (PDA) device 160, according to one or more embodiments. Examples, of the data processing system 104 may include, but are not limited to a laptop, a desktop, a digital calculator, a mobile phone, a personal digital assistant and the like. In one or more embodiments, the data processing system 104 may be electronically coupled to a transmitter device 106 through a generic port, including for example a universal serial bus port of the data processing system 104. Examples of the transmitter device 106 may include, but is not limited to a radio frequency transmitter, radio frequency identification (RFID) interrogator, infra red transmitter, a Bluetooth transmitter, and the like. The system may also include a receiver object 108 detachably attached or affixed to a personal item of the user 103 of the system 100 to protect the personal item of the user 103. The receiver object 108 may be detachably attached or affixed to the personal item through a sticky tape, glue, a double-sided peelable sticker between the receiver object 108 and the personal item, a fastener, Velcro™ and the like.

The transmitting device may be configured to transmit a signal to the receiver object 108 detachably attached to the personal item of the user 103. The signal may include, but is not limited to a radio frequency signal, a microwave signal, a Bluetooth signal, an analog signal, a digital signal and the like. The receiver device may be configured through a software installed in the data processing system 104 to audibly emit a predetermined sound for a predetermined duration of time when the receiver object 108 receives a signal having a certain frequency unique to the receiver object 108. In one or more embodiments, the user 103 may control any number of distinct personal items to recall based on frequency profiles of individual receiver objects associated with each of the individual personal items. Each personal item and/or the receiver object 108 may be associated with a distinct frequency and/or a radio frequency identifier. The system 100 uses different frequencies, for different personal items allowing the user 103 to search for a specific personal item by choosing to transmit a specific frequency signal.

For example, the transmitting device may transmit a 900 MHz signal to locate a key and the receiver object 108 affixed to the key may be configured to respond to only the 900 MHz signal received from the transmitting device and similarly, the transmitting device may be configured to transmit a 800 MHz signal to locate a watch and the receiver object 108 affixed to the watch may be configured to respond to a 800 MHz signal. In one or more embodiments, the receiver object 108 may include a battery, a microcontroller, a receiver, and/or an audio circuit to generate the sound when the receiver object 108 receives the signal having the certain frequency. In one or more embodiments, the transmitter device 106 may be configured through the software installed in the data processing system 104. In one or more embodiments, the software may be downloaded from a third party database (e.g. a website) and installed in the data processing system 104. In one or more embodiments, a cloud computing could be used to obtain the software to program the transmitter device 106 and the receiver object 108. In one or more embodiments, the software may include a web-enabled software.

In one or more embodiments, the software installed in the data processing device may communicate with a remote data processing system 104 through a network 112 to control the transmission of the signal from the transmitter device 106. Examples of the network 112 may include, but is not limited to a wide area network (WAN), a local area network, a wired network, a mobile communication network, Zigbee, a WiFi, a WiMax, and the like. In one or more embodiments, the data processing device may also include a processor of the data processing system 104 configured to authenticate the user 103 of the data processing system 104 and to associate a set of personal items with a set of receiver objects. In one or more embodiments, the association could be manual. In some other embodiments, the association could be automatically performed by the data processing system 104 accessed by the user 103. In one or more embodiments, the processor may also be configured to associate the personal item with the user 103 based on a profile of the user 103 in a user account stored in a data base. The data base may be associated with a server device. The server device may include a local data processing device or a remote data processing device and may be accessible to the user 103 through the data processing device of the user 103 through the network 112.

For example, in one embodiment, if the user 103 has misplaced a personal item at an international destination, or an outdoor location, the user 103 may be able to use a transmitter device 106 that is built into a PDA device (e.g., Bluetooth) to transmit a signal to the receiver object 108 affixed to the misplaced personal item. The user 103 may then be able to locate the misplaced personal item based on the emitted sound. In another embodiment, the user 103 may be able to access the user account 110 associated with the receiver object from a PDA device borrowed from a friend, in order to locate a misplaced personal item. The transmitter device coupled with the PDA device borrowed from the friend may then transmit the signal to the receiver object 108, and the user 103 may be able to locate the misplaced personal item. In one or more embodiments, the operations of the processor may be controllable through the web enabled software. In one or more embodiments, the web enabled software may have a user interface associated with the web enabled software. In one or more embodiments, the user interface may be color coded and/or numerically sequenced for easy identification of the personal item. In one or more embodiments, the user interface may have a link to a website associated with the database including a user account 110 of the user 103. The database may include multiple user accounts of multiple users. Each user account 110 may include a profile of an individual user. In one or more embodiments, a list of personal items associated with the user 103 and the receiver objects affixed to the personal items may be numerically sequenced. The numerical sequence may be saved in the profile of the user 103 in the user account 110. The user 103 may provide inputs to the processor regarding the personal items to be located, by accessing the user interface. In one or more embodiments, the user interface may be accessed by clicking on an icon in the data processing system 104.

The data processing system 104 may acquire the profile information associated with the user account 110 through the server device. In one or more embodiments, the processor may further be configured to determine that the personal item is misplaced based on an input received from the user 103 through the user interface. In one or more embodiments, the processor may also issue a command to transmit the signal to the receiver object 108 affixed to the surface of the personal item. In one or more embodiments, the command may be issued on receiving an input from the user 103 through the user interface of the data processing device. In one or more embodiments, the personal item may be within a predetermined distance, for example, 250 feet, from the data processing system 104 such that the signal can permeate an air space between the data processing system 104 and the receiver device with minimum power consumption.

The system 100 disclosed herein may provide a reliable method of locating misplaced items. In one or more embodiments, the transmitter device 106 may run the web enabled software on the data processing system 104 and may transmit the signal to a corresponding receiver object 108 when the user 103 accesses the user account 110 and selects a particular personal item to locate. The corresponding receiver object 108 affixed on the particular personal item may receive the signal and may emit the predetermined sound. In one or more embodiments, the receiver object 108 may emit the predetermined sound for a predetermined duration. The duration may be configured through the software. The predetermined sound may include a human voice, a default sound programmed into the receiver object 108, a user-programmed sound, and the like. The user 103 may hear the predetermine sound emitted from the receiver object 108 and may locate the personal item. The software and the user interface may track the frequency of usage and allow the user 103 to reorder additional personal items in the profile, access technical support, and/or may allow the downloading of one or more codes associated with the personal items and uploading of user information. In one or more embodiments, the system 100 may allow customization based on user preferences.

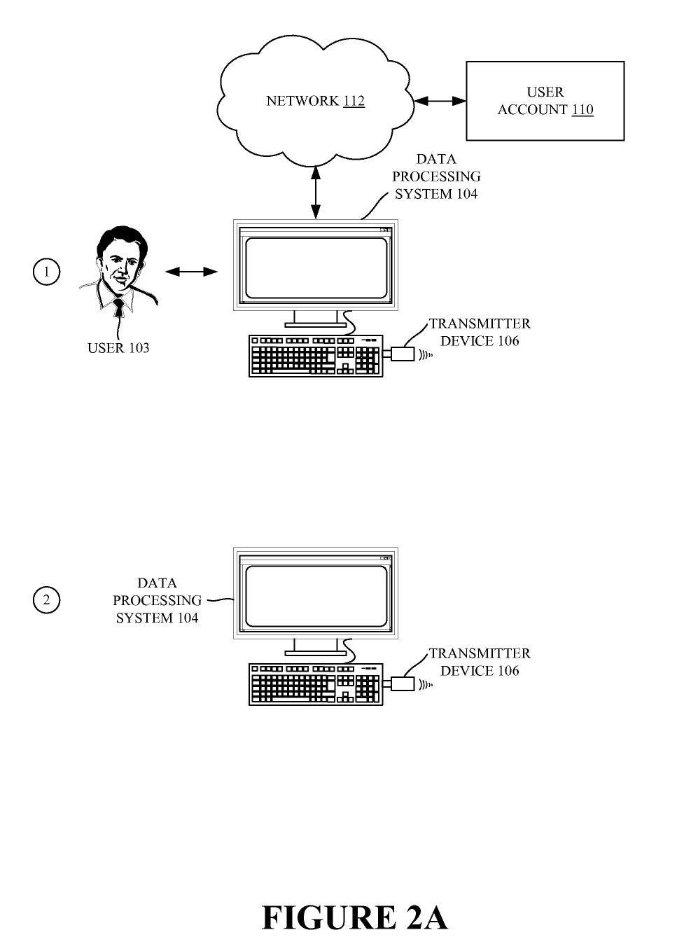

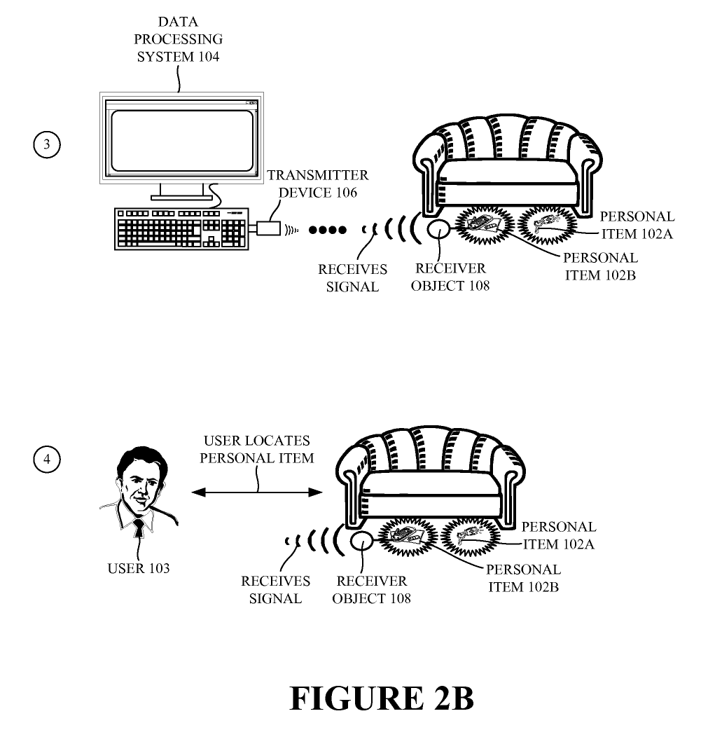

FIGS. 2A-2B is a system view illustrating an interaction flow, according to one or more embodiments. In one or more embodiments, a user 103 of the system 100 may access a data processing system 104 to locate a personal item (e.g., key 102A) of the user 103 misplaced by the user 103. At step 1, the user 103 may select a receiver object 108 associated with the personal item in a user account 110 through a web enabled software installed in the data processing system 104. On receiving user selection, a processor coupled to the data processing system 104 may select a suitable signal to be transmitted to the selected receiver object 108 from the transmitter device 106.

In one or more embodiments, the processor may actuate the transmitter device 106 to transmit the signal to the receiver object 108 by issuing a command to the transmitter device 106. At step 2, the transmitter device 106 may transmit the signal based on the selection by the user 103 in the user account 110. In one or more embodiments, on not hearing any sound as an effect of transmitting the signal, the user 103 may have to move the transmitter and/or the data processing system 104 in different directions to be in close proximity to the personal item misplaced by the user 103. If the receiver object 108 is in an accessible distance from the transmitter device 106 so as to receive the signal, at step 3, the receiver object 108 may receive the signal and may emit a predetermine sound. The user 103 may hear the emitted sound and may move towards the location from where the sound is audible. At step 4, the user 103 may locate the personal item affixed with the receiver object 108 based on hearing the predetermine sound emitted.

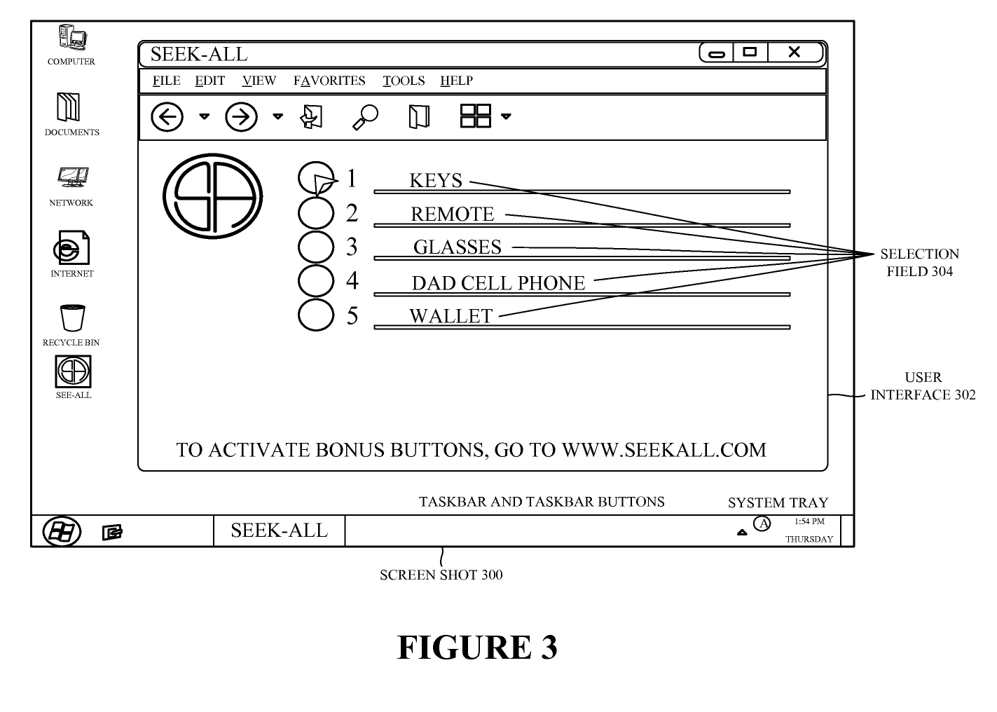

FIG. 3 illustrates a screen shot 300 showing a user interface of the data processing system 104 enabled with a web enabled software to locate a misplaced personal item, in accordance with one or more embodiments. The user interface may receive one or more inputs from a user 103 of the data processing system 104. Examples of the user interface may include, but is not limited to a graphical user interface, a touch interface, and the like. The user interface may include a selection filed as illustrated in FIG. 3. The selection filed may display one or more personal items of the user 103 saved in a user account 110. The user 103 may be allowed to add and/or delete one or more personal items from the selection field 406. The user interface may allow the user 103 to select one or more personal items to be located trough the selection field 304.

The selection field 304 may display one or more options to the user 103, for example, keys, remote, glasses, dad cell phone, and wallet as illustrated in FIG. 3. The user 103 may select one or more of the options. For example, the user 103 may select the option keys to locate the keys. On receiving a selection of the personal item to be located the processor of the data processing system 104 may communicate the selection to the web enabled software. The web enabled software may select a predetermined signal to be transmitted to a receiver object 108 affixed to the personal item to be located, from a transmitter device 106 coupled to the data processing system 104. The process of transmitting the signal from the transmitter after receiving the selection from the user 103 may be performed in real time.

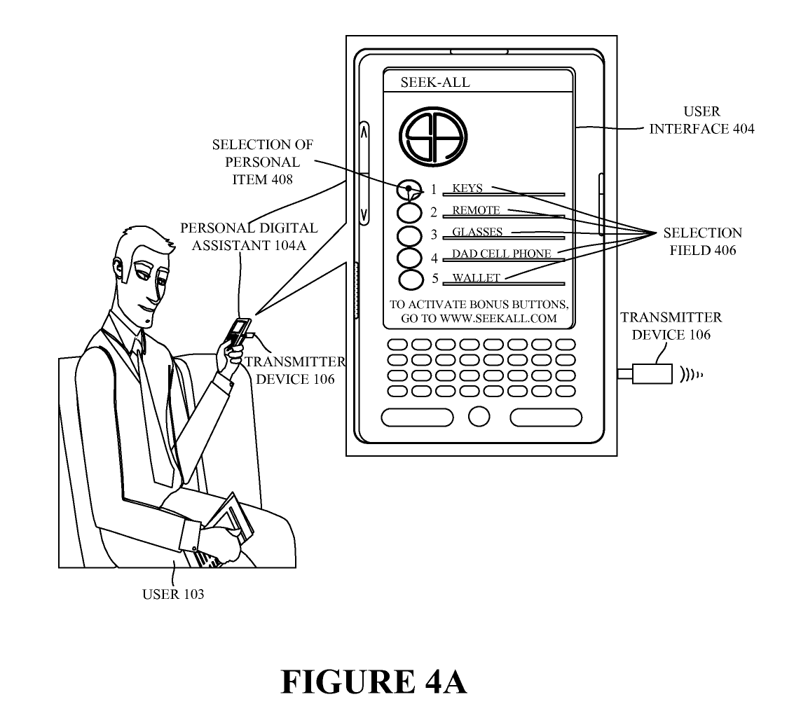

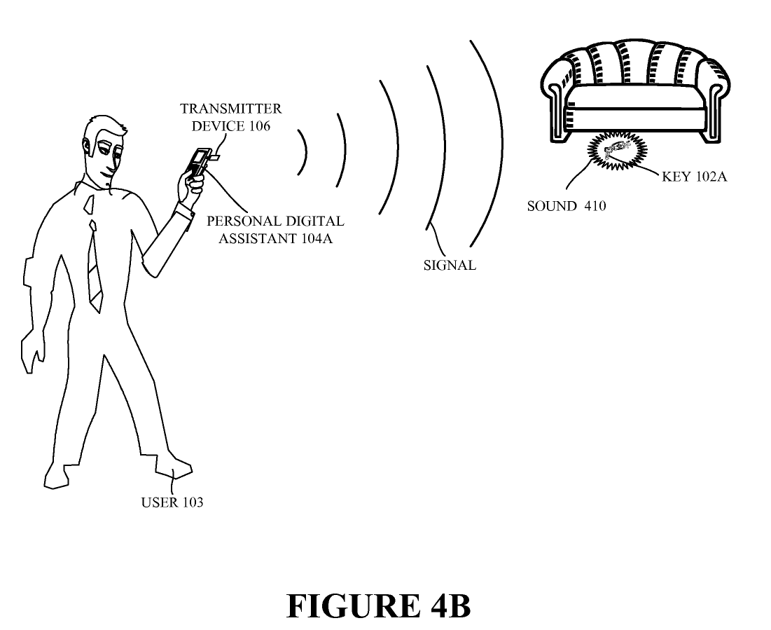

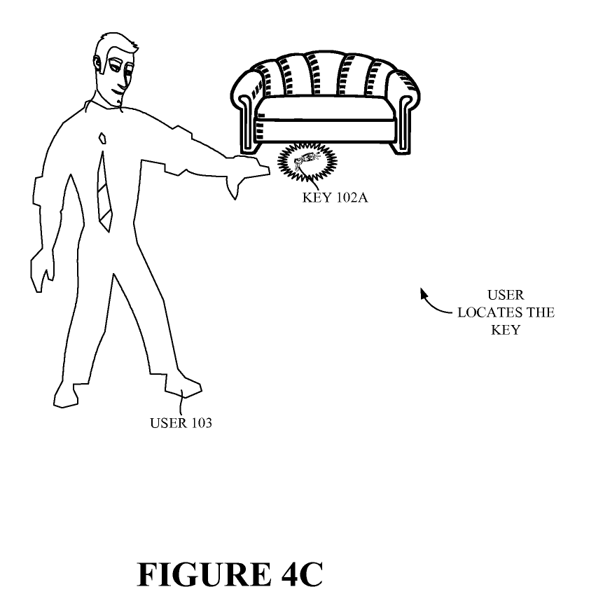

FIGS. 4A-4C illustrate an example scenario of locating a misplaced key of a user 103 through a personal digital assistant 104A of the user 103, in accordance with one or more embodiments. In one or more embodiments, as illustrated in FIG. 4A the user 103 may access a selection field 406 of a user interface 404 of a web enabled software installed in the personal digital assistant 104A of the user 103. In one or more embodiments, the user 103 may select 408 the keys option in the selection field 406 of the user interface 404 as illustrated in FIG. 4A. On receiving the selection from the user 103, a transmitter device 106 coupled to the personal digital assistant 104A may transmit a radio frequency signal to locate the key of the user 103. The transmitted signal may be received by a receiver object 108 coupled to the key and the receiver object 108 may emit a sound audible to the user 103. On hearing the sound the user 103 may approach the receiver object 108 emitting the sound as illustrated in FIG. 4B. The user 103 may locate the key hidden under a sofa as illustrated in FIG. 4C based on hearing the emitted sound from the receiver object 108 affixed to the key.

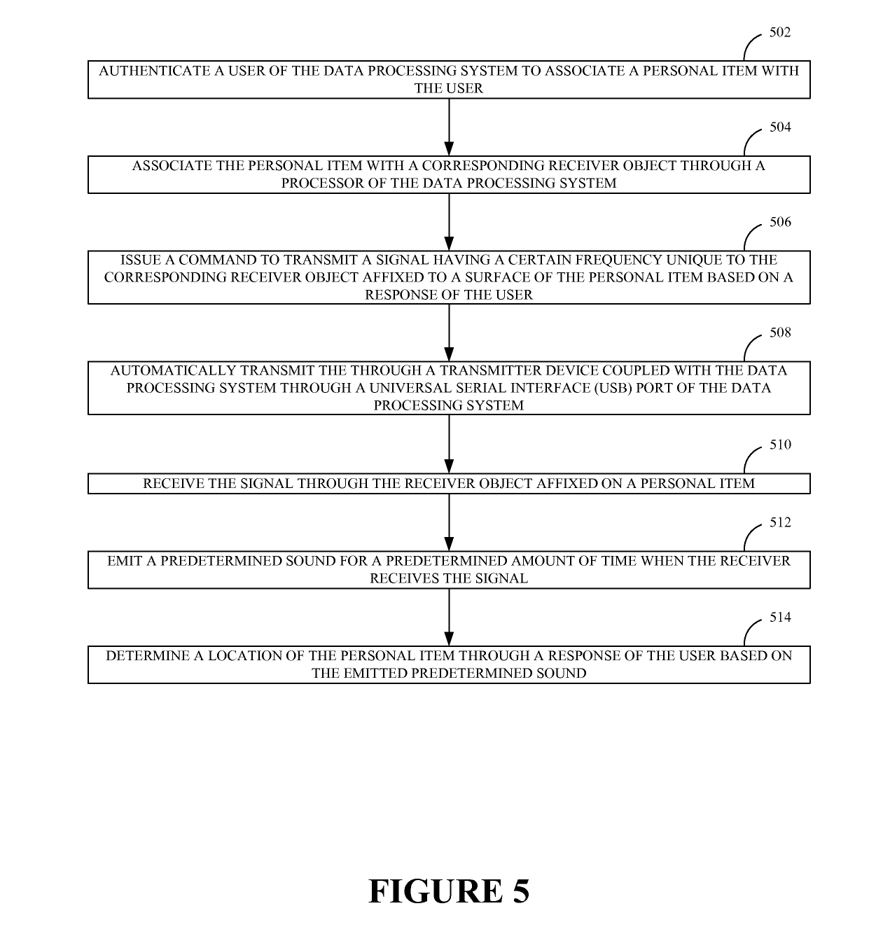

FIG. 5 is a flow diagram illustrating a method of locating a personal item of a user of a data processing system misplaced by the user, in accordance with one or more embodiments. Examples of the data processing system may include, but is not limited to, a laptop, a desktop, a mobile communication device, a personal digital assistant, and the like. In one or more embodiment, at step 502, a system disclosed herein authenticates the user to associate a personal item with the user. Examples of the personal item may include, but is not limited to a key, a key chain, an electronic device, a set of eyeglasses, a jewelry item, any item having personal value to the user and the like. The authentication may be through logging into a website associated with a web-enabled software installed in the data processing system and accessed by the user through the data processing system. In one or more embodiments, the user may log into the website through a user interface of the web-enabled software provided in the data processing system. The user interface may display a list of one or more personal items associated the user, the list saved in a database associated with the website. In one or more embodiments, at step 504, the personal item may be associated with a corresponding receiver object through a processor of the data processing system.

The processor may also configure the receiver object to respond to a particular frequency received from a transmitter device coupled to the data processing system. Examples of the transmitter device 106 may include, but is not limited to a radio frequency transmitter, radio frequency identification (RFID) interrogator, infra red transmitter, a Bluetooth transmitter, and the like. In one or more embodiments, the transmitter device may be coupled to the data processing system through a Universal Serial Interface (USB) port of the data processing system. The web-enabled software may be used to configure the receiver object and the transmitter device. In one or more embodiments, at step 506, the processor issues a command to actuate the transmitter device coupled with the data processing system, to transmit a signal having a certain frequency unique to the corresponding receiver object affixed to a surface of the personal item based on a response of the user. In one or embodiments, at step 508, the transmitter device coupled with the data processing system automatically transmits the signal.

Examples of the data processing system may include, but is not limited to a personal computer, a laptop, a personal digital assistant, a mobile communication device, and the like. The transmitter device may operate on one or may of a radio frequency, a microwave signal, an infra red signal, an analog signal, and a digital signal. In one or more embodiments, at step 510, the receiver object affixed on a personal item receives the transmitted signal. In one or more embodiments, at step 512, the receiver object emits a predetermined sound for a predetermined amount of time when the receiver object receives the signal. In one or embodiments, at step 514, the system determines a location of the personal item through a response of the user based on the emitted predetermined sound.

In one or embodiments, a set of operations associated with the processor may be controlled through a web enabled software. In one or more embodiments, a user account associated with the user may be stored in a server device accessible through the web enabled software. In one or more embodiments, a set of options associated with a group of receiver objects may be selected through the user account by the user. The set of options associated with the set of receiver objects may be one or more of a set of frequency profiles of the receiver objects, a set of options associated with personal information stored in the user account, and a set of display options of the user account. A user interface associated with the web enabled software may be color coded and/or numerically sequenced for easy identification of the personal item. In one or more embodiments, the system tracks a frequency of a usage of the receiver objects by the user and may allow the user to reorder a set of additional components, to access a technical support information, to download a set of component codes, and to upload a set of user information based on the usage.

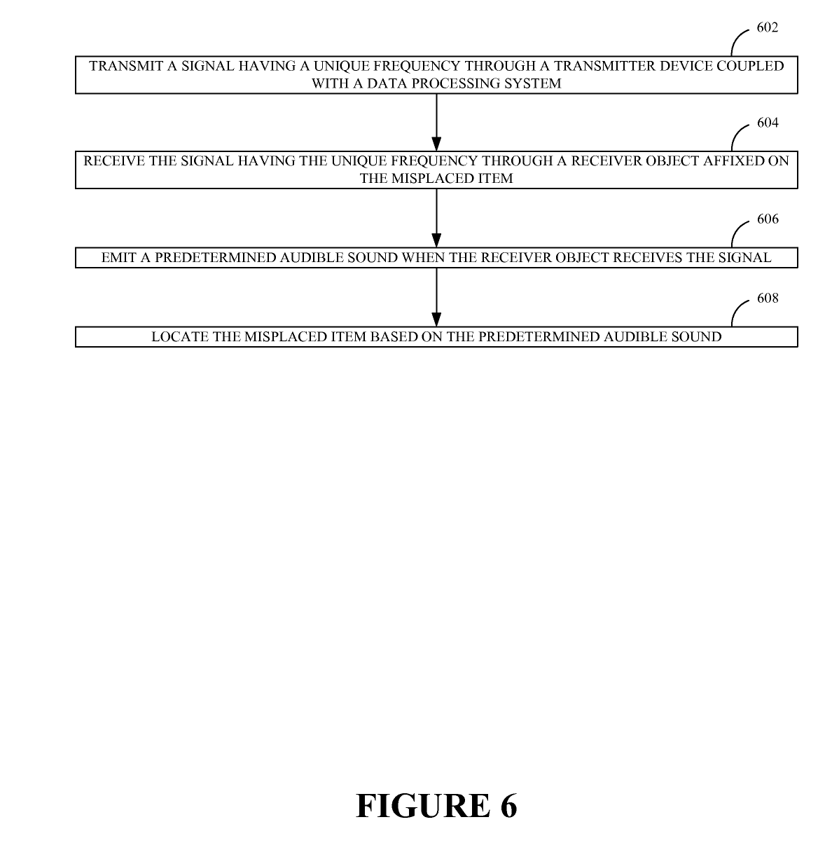

FIG. 6 is a flow diagram illustrating a method of locating a personal item of a user misplaced by the user, in accordance with one or more embodiments. In one or more embodiments, a user selects a set of points associated with the receiver object in a user account accessible through a web enabled software. In one or more embodiments, at step 602, a transmitter device coupled with a data processing system transmits a signal having a unique frequency. In one or more embodiments, at step 604, a receiver object affixed on the misplaced item receives the signal having the unique frequency. In one or more embodiments, at step 606, a predetermined audible sound is emitted when the receiver object receives the signal. In one or more embodiments, at step 608, the misplaced item may be located based on the predetermined audible sound.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of Microsoft Windows, Apple Mac, Unix/X-Windows, Linux, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network. One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion. While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

What is claimed is:

1. A system comprising:
a personal item;
a receiver object affixed on a surface of the personal item to audibly emit a predetermined sound for a predetermined amount of time when the receiver object receives a signal having a certain frequency unique to the receiver object;
a transmitter device electronically coupled with a data processing system;
a processor of the data processing system:
to authenticate a user of the data processing system;
to associate a set of personal items with a set of receiver objects;
to associate the personal item with the user based on a profile of the user;
to determine that the personal item is misplaced based on a response of the user; and
to issue the command to transmit the signal to the receiver object affixed to the surface of the personal item.

2. The system of claim 1 wherein the receiver object comprises a battery, a microcontroller, a receiver, and an audio circuit to generate the sound when the receiver object receives the signal having the certain frequency.

3. The system of claim 1:
wherein the data processing system is at least one of a personal computer, a laptop, a personal digital assistant, and a mobile communication device,
wherein the personal item is any one of a key, a key chain, an electronic device, a set of eyeglasses, a jewelry item, and any item having personal value to the user, and
wherein the transmitter device is electronically coupled with the data processing system through at least one of a Universal Serial Interface (USB) port of the data processing system, an in-built wireless technology of the data processing system and an in-built Bluetooth technology of the data processing system.

4. The system of claim 1 wherein the receiver object is affixed to the personal item through a sticky tape, a glue, and a double-sided peelable sticker between the receiver object and the personal item.

5. The system of claim 1 wherein the transmitter device operates on at least one of a radio frequency, a microwave signal, a Bluetooth signal, an analog signal, and a digital signal.

6. The system of claim 1 wherein the operations of the processor are controllable through a web enabled software in which a user account associated with the user is stored in a server device and wherein the data processing system acquires a profile information associated with the user account through the server device and wherein the user controls any number of distinct personal items to recall based on frequency profiles of individual ones of the distinct personal items.

7. The system of claim 6 wherein a user interface associated with the web enabled software is color coded and numerically sequenced for easy identification of the personal item.

8. The system of claim 1 wherein the personal item is within 250 feet of the data processing system such that the signal can permeate an air space between the data processing system and the receiver device with minimum power consumption.

9. The system of claim 1 wherein the system provides a reliable method of locating misplaced items.

10. The system of claim 1 wherein the transmitter device runs the web enabled software on the data processing system and transmits the signal to a corresponding receiver object when the user accesses the user account and selects a particular personal item to locate and wherein the corresponding receiver object affixed on the particular personal item receives the signal and emits the predetermined sound.

11. The system of claim 11 wherein the predetermined sound is at least one of a human voice, a default sound programmed into the receiver object and a user-programmed sound.

12. A method comprising:
authenticating a user of the data processing system to associate a personal item with the user;
associating the personal item with a corresponding receiver object through a processor of the data processing system;
issuing a command to transmit a signal having a certain frequency unique to the corresponding receiver object affixed to a surface of the personal item based on a response of the user;
automatically transmitting the signal through a transmitter device coupled with the data processing system through a Universal Serial Interface (USB) port of the data processing system;
receiving the signal through the receiver object affixed on a personal item;
emitting a predetermined sound for a predetermined amount of time when the receiver receives the signal; and
determining a location of the personal item through a response of the user based on the emitted predetermined sound.

13. The method of claim 12 further comprising:
controlling a set of operations associated with the processor through a web enabled software;
storing a user account associated with the user in a server device accessible through the web enabled software; and
selecting, through the user account, a set of options associated with a group of receiver objects.

14. The method of claim 13 wherein the set of options associated with the set of receiver objects is at least one of a set of frequency profiles of the receiver objects, a set of options associated with personal information stored in the user account, and a set of display options of the user account.

15. The method of claim 13 wherein a user interface associated with the web enabled software is color coded and numerically sequenced for easy identification of the personal item.

16. The method of claim 12
wherein the data processing system is at least one of a personal computer, a laptop, a personal digital assistant, and a mobile communication device, and
wherein the personal item is any one of a key, a key chain, an electronic device, a set of eyeglasses, a jewelry item, and any item having personal value to the user.

17. The method of claim 12 wherein the transmitter device operates on at least one of a radio frequency, a microwave signal, an analog signal, and a digital signal.

18. The method of claim 12 further comprising:
permitting the user to track a frequency of a usage of the receiver objects, to reorder a set of additional components, to access a technical support information, to download a set of component codes, and to upload a set of user information.

19. A method of locating a misplaced item comprising:
transmitting a signal having a unique frequency through a transmitter device coupled with a data processing system;
receiving the signal having the unique frequency through a receiver object affixed on the misplaced item;
emitting a predetermined audible sound when the receiver object receives the signal; and
locating the misplaced item based on the predetermined audible sound.

20. The method of locating a misplaced item of claim 19 further comprising:
permitting a user to select a set of options associated with the receiver object in a user account accessible through a web enabled software.
